(19) United States
(12) Patent Application Publication
(10) Pub. No.: US 2023/0113793 A1
(43) Pub. Date: Apr. 13, 2023

(54) SERVICE PROVISION SYSTEM, SERVICE PROVISION METHOD, MANAGEMENT APPARATUS, ANDCOMPUTER-READABLE RECORDING MEDIUM

(71) Applicant: NEC Corporation, Minato-ku, Tokyo (JP)

(72) Inventors: Honami YUKI, Tokyo (JP); Shuuji KIKUCHI, Tokyo (JP); Rumi TACHIBANA, Tokyo (JP); Yang LU, Tokyo (JP)

(73) Assignee: NEC Corporation, Minato-ku, Tokyo (JP)

(21) Appl. No.: 17/909,559

(22) PCT Filed: Mar. 17, 2020
(86) PCT No.: PCT/JP2020/011739

§ 371 Date: Sep. 6, 2022

(51) Int. Cl. G06Q 20/40; H04L 9/40; G06Q 10/083

(52) U.S. Cl. CPC G06Q 20/40145; H04L 63/0861; G06Q 10/083

(57) ABSTRACT

There is provided a service provision system including: a management apparatus 100; and a service provision apparatus 200, the management apparatus 200 including: a biometric authentication means 110 for performing biometric authentication of a user, based on biometric information of the user transmitted from a terminal device 300; and a service request means 120 for requesting, if the user is authenticated, the service provision apparatus 200 to provide an item to be used by the user, and the service provision apparatus 200 including: a service acceptance means 210 for receiving the request for provision of the item from the management apparatus 100, and accepting the request for provision of the item to the user who is biometrically authenticated.

### TECHNICAL FIELD

The present invention relates to a service provision system, a service provision method and a management apparatus in which the service provision system is used, and also to a computer readable recording medium having recorded thereon a program for realizing the apparatus and method.

### BACKGROUND ART

When traveling for holidays, business trips and the like, the burden of tasks such as preparing items that will be needed at the travel destination and carrying large pieces of luggage at the destination tends to fall on the tourist or business traveler. In order to reduce the burden of tasks such as packing and carrying luggage, a service is provided for items that will be needed at the travel destination to be rented at the destination, as described in Non-Patent Document 1, for example. This service enables tourists and business travelers to use items that they will be need at the travel destination by requesting the necessary items from a rental operator beforehand. Tourists and business travelers thereby no longer need to get ready beforehand or carry large pieces of luggage at their travel destination, and can thus travel lightly and relax at their destination.

### LIST OF RELATED ART DOCUMENTS

### Non-Patent Document

Non-Patent Document 1: KUROKO Inc., “Traveling light”, retrieved 31 Jan. 2020, from https://teburatabi.com

### SUMMARY OF INVENTION

### Problems to be Solved by the Invention

However, there is a possibility that items rented by users are returned in a damaged state or the like, and rental operators could also suffer losses. Also, at the time of renting items, it is common for information such as a receipt number required at the time of receiving the items to be notified by e-mail or the like to the person who is requesting use of the rental service. However, with such a mechanism, it is possible for a person other than the user to impersonate the user and use the receipt number to rent items. Thus, a mechanism is required that realizes reliable transactions and enables rental operators to rent out items with peace of mind.

An example of an object of the invention is to provide a service provision system, a management apparatus, a service management method and a computer-readable recording medium that allow for reliable transactions between service providers and users.

### Means for Solving the Problems

In order to achieve the aforementioned object, there is provided a service provision system including:

a management apparatus; and

a service provision apparatus,

the management apparatus including:

a biometric authentication unit configured to perform biometric authentication of a user, based on biometric information of the user transmitted from a terminal device; and

a service request unit configured to request, if the user is authenticated, the service provision apparatus to provide an item to be used by the user, and

the service provision apparatus including:

a service acceptance unit configured to receive the request for provision of the item from the management apparatus, and accepting the request for provision of the item to the user who is biometrically authenticated.

Also, in order to achieve the aforementioned object, there is provided a service provision method including:

performing biometric authentication of a user, based on biometric information of the user transmitted from a terminal device;

requesting, if the user is authenticated, provision of an item to be used by the user; and

receiving the request for provision of the item, and accepting the request for provision of the item to the user who is biometrically authenticated.

Furthermore, in order to achieve the aforementioned object, there is provided a management apparatus including:

a biometric authentication unit configured to perform biometric authentication of a user, based on biometric information of the user transmitted from a terminal device; and

a service request unit configured to request, if the user is authenticated, provision of an item to be used by the user.

Also, in order to achieve the aforementioned object, there is provided a computer-readable recording medium including a program recorded thereon, the program including instructions that cause a computer to carry out:

performing biometric authentication of a user, based on biometric information of the user transmitted from a terminal device;

requesting, if the user is authenticated, provision of an item to be used by the user; and

receiving the request for provision of the item, and accepting the request for provision of the item to the user who is biometrically authenticated.

### Advantageous Effects of the Invention

As described above, according to the present invention, it can be allow for reliable transactions between service providers and users.

### BRIEF DESCRIPTION OF THE DRAWINGS

FIG. 1 is a block diagram showing an example configuration of the service provision system according to the first example embodiment of the invention.

FIG. 2 is a schematic configuration diagram showing a network configuration of the subscription service to which the service provision system according to the present example embodiment is applied.

FIG. 3 is a block diagram showing an example configuration of the service provision system according to the present example embodiment applied to the subscription service.

FIG. 4 is a sequence diagram showing processing at the time of item provision by the service provision system according to the present example embodiment.

FIG. 5 is a block diagram showing an example configuration of the service provision system according to the second example embodiment of the invention.

FIG. 6 is a sequence diagram showing processing for sending recommendation information by the service provision system according to the present example embodiment.

FIG. 7 is an illustrative diagram showing an example of when the recommendation information distribution processing by the service provision system according to the present example embodiment is implemented in the subscription service for providing items shown in FIG. 2.

FIG. 8 is a block diagram illustrating an example configuration of the service provision system according to the third example embodiment of the invention.

FIG. 9 is a sequence diagram showing processing for purchasing an item by the service provision system according to the present example embodiment.

FIG. 10 is an illustrative diagram showing an example of when payment processing by the service provision system according to the present example embodiment is implemented in the subscription service for providing items shown in FIG. 2.

FIG. 11 is a block diagram illustrating one example of the computer that realizes the management apparatus and the service provision apparatus according to a plurality of example embodiment.

### EXAMPLE EMBODIMENTS

### 1. First Example Embodiment

[1-1. System Configuration]

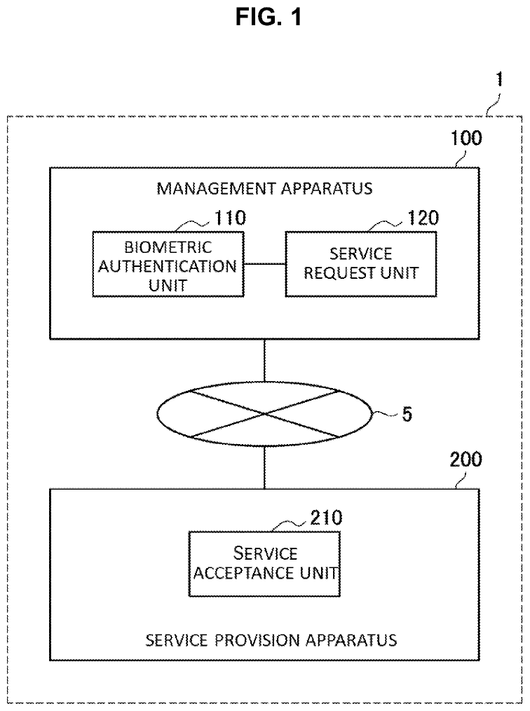

First, a schematic configuration of a service provision system 1 according to a first example embodiment of the invention will be described based on FIG. 1. FIG. 1 is a block diagram showing an example configuration of the service provision system 1 according to the first example embodiment of the invention.

The service provision system according to the present example embodiment is a system for providing a service that provides items to users. In the service provision system 1 according to the present example embodiment, a management apparatus 100 and a service provision apparatus 200 are connected via a network 5, as shown in FIG. 1.

The management apparatus 100 is a device for managing transactions between service providers and users. The management apparatus 100 has a biometric authentication unit 110 and a service request unit 120. The biometric authentication unit 110 performs biometric authentication of a user, based on biometric information of the user transmitted from a terminal device. If the user is authenticated by the biometric authentication unit 110, the service request unit 120 requests the service provision apparatus 200 to provide items to be used by the user.

The service provision apparatus 200 is a device for performing processing for procuring items with business operators in order to provide a service to users. The service provision apparatus 200 has a service acceptance unit 210. The service acceptance unit 210 accepts requests, from the management apparatus 100, for provision of items to biometrically authenticated users. Upon accepting a request for provision of an item, the service acceptance unit 210 requests an item provision operator to secure the item and requests a logistics operator to deliver the item, for example.

In the service provision system 1, biometric authentication is implemented for identity verification purposes, at the time that a user receives provision of an item from a business operator. If the user is authenticated by the biometric authentication unit 110, it becomes possible for the user to use the item, and the management apparatus 100 requests the service provision apparatus 200 to provide the item to the user. By implementing biometric authentication on the user at the time that he or she receives provision of the item, the user who is using the service can be specified. As a result, it is possible to prevent problems such as rental items being returned in a damaged state and items being used by another person impersonating the user. In this way, the service provision system 1 makes reliable transactions possible between service providers and users.

[1-2. Application to Subscription Service]

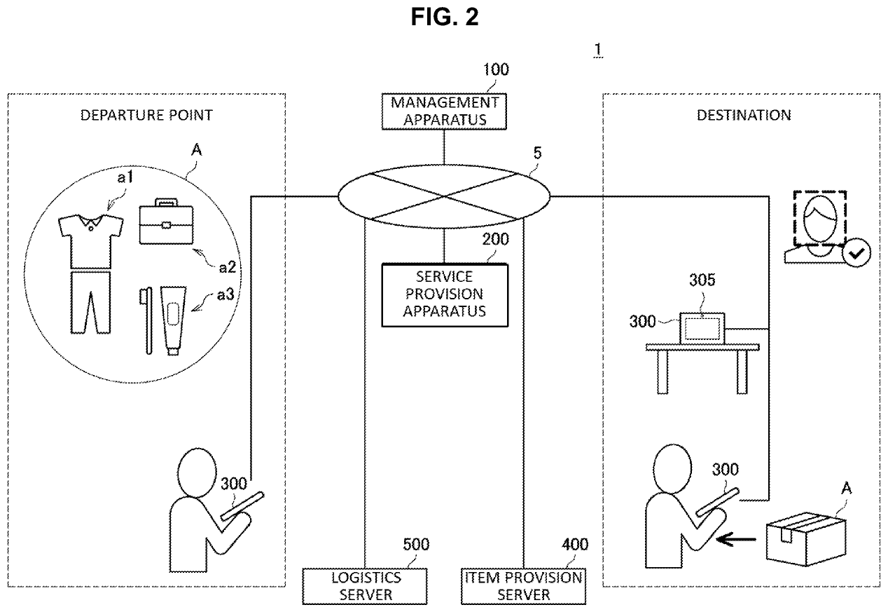

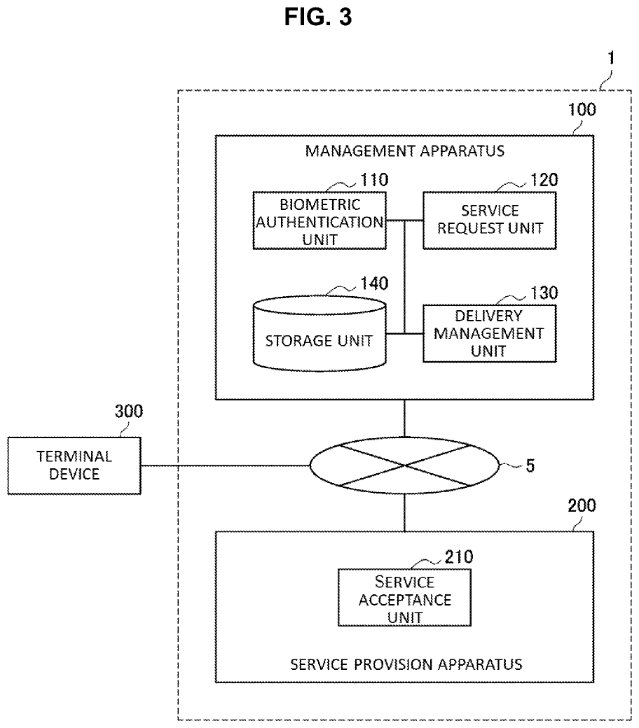

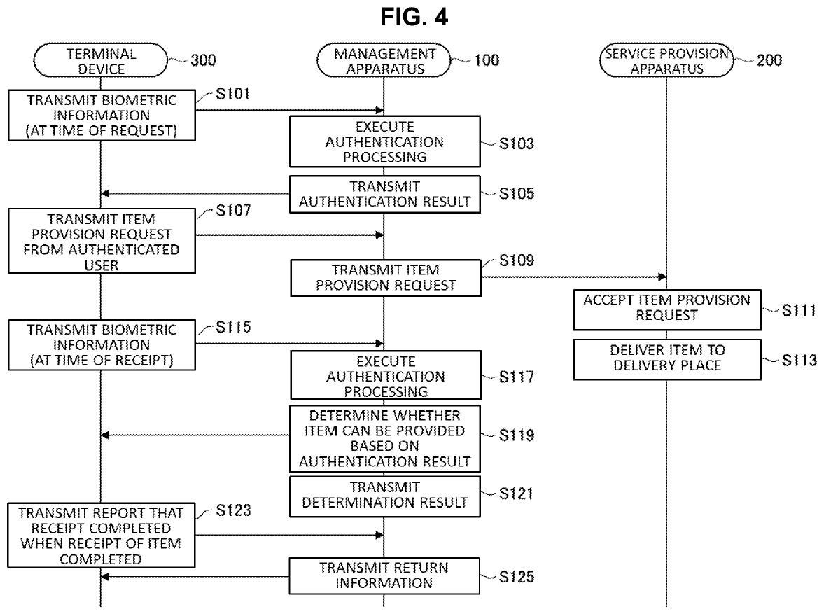

Next, service provision processing by the service provision system 1 according to the present example embodiment will be described based on FIGS. 2 to 4. Hereinafter, the case where the service provision system 1 according to the present example embodiment is applied to a subscription service will be described as a specific example. FIG. 2 is a schematic configuration diagram showing a network configuration of the subscription service to which the service provision system 1 according to the present example embodiment is applied. FIG. 3 is a block diagram showing an example configuration of the service provision system 1 according to the present example embodiment applied to the subscription service. FIG. 4 is a sequence diagram showing processing at the time of item provision by the service provision system 1 according to the present example embodiment.

(Service Overview)

The subscription service shown in FIG. 2 is a service for providing users with necessary items at their destination. In the service provision system 1 of the subscription service shown in FIG. 2, the management apparatus 100 and the service provision apparatus 200 shown in FIG. 1, a terminal device 300, an item provision server 400 and a logistics server 500 are connected via the network 5. The terminal device 300 is a device for a user to input information, display information, and so on. The item provision server 400 is a device for performing processing for managing items in the item provision operator. The logistics server 500 is a device for performing processing for managing delivery of items in the logistics operator.

It is assumed that, at the time of using this subscription service, the user has already completed user registration for using the service. In the user registration, biometric information of the user is registered, and the biometric information is recorded in a storage unit (storage unit 140 in FIG. 3) in association with a unique user ID assigned to the user. The biometric information that is recorded in the storage unit is also referred to as registered biometric information. Information on a body part from which a feature amount unique to the user can be extracted is used as biometric information. For example, information on the face, fingerprints, iris, veins and the like is used as biometric information. The biometric information is acquired as an image or video by an image capturing apparatus, for example, and the acquired image or video, or a feature amount that is extracted therefrom is recorded in the storage unit. At this time, registration of user information such as the user's name, address and e-mail address may also be accepted, and may be recorded in the storage unit in association with the user ID. Furthermore, certificate information of the user such as passport information may be recorded in the storage unit in association with the user ID and registered biometric information.

The user requests provision of an item A that will be needed at his or her travel destination using the terminal device 300 at the departure point, for example. Items that can be provided to the user include clothing al, a bag a2 and consumables such as a toothbrush a3. With the subscription service, users are able to use the service within a service range for a fixed period.

Users are thus able to receive provision of necessary items without worrying about an increase in cost, as compared to a rental service that requires payment of a rental fee for each item.

Also, the service disclosed in Non-Patent Document 1, for example, mainly focuses on clothing as items to be provided, and does not provide consumables necessary at a travel destination such as toothbrushes. Users such as tourists and business travelers thus need to provide their own consumables. With the subscription service, given that it is easy to incorporate consumables into the items that are provided, it is possible to provide a more convenient service. This service enables users to travel lightly and relax at their destination, without having to get items that they will need at their destination ready beforehand or carry large pieces of luggage at their destination. Note that users are also able to request provision of items at their destination, using the terminal device 300, without necessarily needing to request items at their departure point.

When a user uses the subscription service, the management apparatus 100 requests the terminal device 300 to transmit biometric information of the user, in order to confirm that the service is available for use by that user. The terminal device 300 acquires biometric information of the user and transmits the acquired biometric information to the management apparatus 100.

The management apparatus 100 performs authentication processing based on the received biometric information, and, if the user is authenticated, requests the service provision apparatus 200 to provide the item to the user. Upon receiving the request for provision of the item, the service provision apparatus 200 requests the item provision server 400 to secure the item, and requests the logistics server 500 to deliver the item, via the network 5. The item A requested by the user is thus procured and delivered to the delivery place at the travel destination. When the procurement of the item A is completed, the management apparatus 100 may notify the terminal device 300 of the completion of procurement and notify guidance about the delivery place. This notification may be given by e-mail, for example.

At the time that the user receives the item A at the travel destination, the management apparatus 100 requests the terminal device 300 to transmit biometric information of the user. At this time, the terminal device 300 may be a device in the possession of the user such as a smartphone or may be a device installed at the delivery place of the item A. The terminal device 300 acquires biometric information of the user and transmits the acquired biometric information to the management apparatus 100. The management apparatus 100 performs authentication processing based on the received biometric information, and, if the user is authenticated, permits provision of the item A to the user. In this way, by using biometric authentication to verify the identity of the user who is to receive the item, reliable transactions can be realized between service providers and users.

(System Configuration)

The block diagram in FIG. 3 shows functional units of the service provision system 1 that function from when a user who uses the subscription service shown in FIG. 2 requests an item until when the item is received. As shown in FIG. 3, the service provision system 1 has the management apparatus 100 and the service provision apparatus 200. The management apparatus 100, the service provision apparatus 200 and the terminal device 300 are connected via the network 5.

The management apparatus 100 includes the biometric authentication unit 110, the service request unit 120, a delivery management unit 130, and the storage unit 140. The biometric authentication unit 110 and the service request unit 120 of the management apparatus 100 and the service acceptance unit 210 of the service provision apparatus 200 respectively function as described with FIG. 1. A detailed description thereof will thus be omitted here.

The delivery management unit 130 manages the delivery of items to users. Once the user is authenticated by the biometric authentication unit 110 based on biometric information of the user acquired at the delivery place of the item, the delivery management unit 130 notifies the terminal device 300 via the network 5 that the item is available for pickup.

The storage unit 140 stores various information required in order for the management apparatus 100 to manage transactions between service providers and users in the service provision system 1. The storage unit 140 stores biometric information of a user in association with the unique user ID assigned to the user, for example. Also, user information such as name, address and e-mail address is recorded in the storage unit 140 in association with the user ID.

(Service Provision Processing)

Hereinafter, processing of the service provision system 1 from request to receipt of an item by a user who uses the subscription service shown in FIG. 2 will be described based on FIG. 4. It is assumed that, at the time of using this subscription service, the user has already completed user registration for using the service.

First, the user selects an item to be provided by the subscription service and requests provision. In order to use the service, the user acquires biometric information using the terminal device 300, and transmits the acquired biometric information to the management apparatus 100 (S101). For example, when performing identity verification by facial recognition, the terminal device 300 acquires a facial image using an image capturing apparatus 305 and transmits the captured facial image to the management apparatus 100. The image capturing apparatus 305 may be a camera provided in the terminal device 300. Alternatively, the image capturing apparatus 305 may be a separate device from the terminal device 300, and may be capable of transmitting the acquired image to the terminal device 300.

The management apparatus 100, having received the biometric information from the terminal device 300, uses the biometric authentication unit 110 to perform identity verification through comparison with the biometric information recorded in advance in the storage unit 140 (S103). The biometric authentication unit 110 transmits the authentication result to the terminal device 300 (S105).

The terminal device 300 notifies the authentication result received in step S105 to the user. If the user was not authenticated, the terminal device 300 acquires biometric information of the user again and executes processing from step S101. On the other hand, if the user was authenticated, it becomes possible for the user to use the service.

The user, having become able to use the service, selects an item using the terminal device 300, and transmits a request for provision of the selected item to the management apparatus 100 (S107). The management apparatus 100, having received the item provision request, transmits the item provision request to the service provision apparatus 200 (S109). The service provision apparatus 200 accepts the item provision request (5111). The service provision apparatus 200 then requests the item provision server 400 to secure the item and requests the distribution server 500 to deliver the item, via the network 5, such that the item is delivered to the delivery place. The item requested by the user is thus procured and delivered to the delivery place by a designated date-time (S113).

Thereafter, the user receives the item at the delivery place on the designated date-time. At the time that the user receives the item, the management apparatus 100 uses the delivery management unit 130 for identity verification purposes to request a terminal device 300 that is at the delivery place to transmit biometric information of the user. The terminal device 300 may be a device in the possession of the user such as a smartphone or may be a device installed at the delivery place of the item. The terminal device 300 acquires the biometric information of the user and transmits the acquired biometric information to the management apparatus 100 (S115).

Having received the biometric information from the terminal device 300, the management apparatus 100 uses the biometric authentication unit 110 for identity verification purposes to perform comparison with the biometric information recorded in advance in the storage unit 140 (S117). The biometric authentication unit 110 compares the biometric information, and outputs the authentication result to the delivery management unit 130. The delivery management unit 130 determines whether the item can be provided based on the authentication result by the biometric authentication unit 110 (S119), and transmits the determination result to the terminal device 300 via the network 5 (S121).

That is, if the user was not authenticated, the delivery management unit 130 transmits notification that the user was not authenticated and a request for retransmission of biometric information to the terminal device 300. In this case, the user acquires biometric information of the user again using the terminal device 300 and executes processing from step S115.

On the other hand, if the user was authenticated, the delivery management unit 130 transmits notification to the terminal device 300 via the network 5 that the item is available for pickup. Upon receiving the item, the user uses the terminal device 300 to transmit a report to the management apparatus 100 that receipt of the item is completed (S123). The management apparatus 100 is thereby able to recognize that the item has been provided to the user.

Thereafter, the management apparatus 100 may transmit notification that receipt of the item by the user is completed or return information of the provided item to the terminal device 300 (S125). The return information includes the return place of the item and the return deadline, for example. The user need only return the item to the return place by the return deadline. At this time, in the case where return of the item by the user himself or herself is required, for example, identity verification by biometric authentication may be implemented at the return place, similarly to when the user received the item.

Note that, regarding receipt of items by users, there are also cases where a user requests provision of a plurality of items, as shown in FIG. 2. At this time, the service request unit 120 of the management apparatus 100 may notify confirmation as to whether the plurality of items are to be received at the same time to the terminal device 300 of the user. Upon receiving this notification, the user transmits a reply as to whether the requested plurality of items are to be received at the same time to the management apparatus 100, using the terminal device 300. If a request for receipt of the plurality of items at the same time is received from the terminal device 300, the management apparatus 100 notifies a request for delivery of the plurality of items at the same time to the service provision apparatus 200.

Also, in the above description, the delivery place of items may be a manned place such as a hotel front desk or a store, for example. Alternatively, in the case where a locker at a hotel, train station, airport or the like is provided with a terminal device 300, the locker can also be used as the delivery place of items. In this case, the user inputs biometric information using the terminal device 300 with which the locker is provided. The management apparatus 100 need only perform comparison of the input biometric information, and, if the user is authenticated, unlock the door of the locker in which the items are stored.

Hereinabove, the configuration of the service provision system 1 according to the first example embodiment and the service provision processing that is implemented by the service provision system 1 are described. According to the present example embodiment, biometric authentication is implemented for identity verification purposes, at the time that a user receives provision of an item from a business operator. If the user is authenticated by the biometric authentication unit 110, it becomes possible for the user to use the item. Also, by implementing biometric authentication on the user at the time that he or she receives provision of the item, the user who is using the service can be specified. As a result, it is possible to prevent problems such as rental items being returned in a damaged state and items being used by another person impersonating the user. In this way, the service provision system 1 makes it possible for service providers and users to transact reliably.

Note that a program for executing the service provision processing in the service provision system 1 according to the present example embodiment need only be a program that causes a computer to execute processing as the functional units shown in FIG. 1 or FIG. 3. By installing and executing this program on a computer, the management apparatus 100 and the service provision apparatus 200 of the service provision system 1 and the service provision method according to the present example embodiment can be realized. In this case, the processor of the computer functions and performs processing as the biometric authentication unit 110, the service request unit 120 and the delivery management unit 130 of the management apparatus 100. Alternatively, the processor of the computer functions and performs processing as the service acceptance unit 210 of the service provision apparatus 200.

Also, in the present example embodiment, the storage unit 140 may be realized by storing data files constituting the same in a storage device such as a hard disk provided in the computer, or may be realized by a storage device of another computer. Examples of the computer include a smartphone and a tablet terminal device, in addition to a general-purpose PC.

Furthermore, the program according to the present example embodiment may be executed by a computer system constructed from a plurality of computers. In this case the computers may, for example, respectively function as one of the biometric authentication unit 110, the service request unit 120, the delivery management unit 130 and the payment processing unit 170 of the management apparatus 100 and the service acceptance unit 210 of the service provision apparatus 200.

### 2. Second Example Embodiment

[2-1. System Configuration]

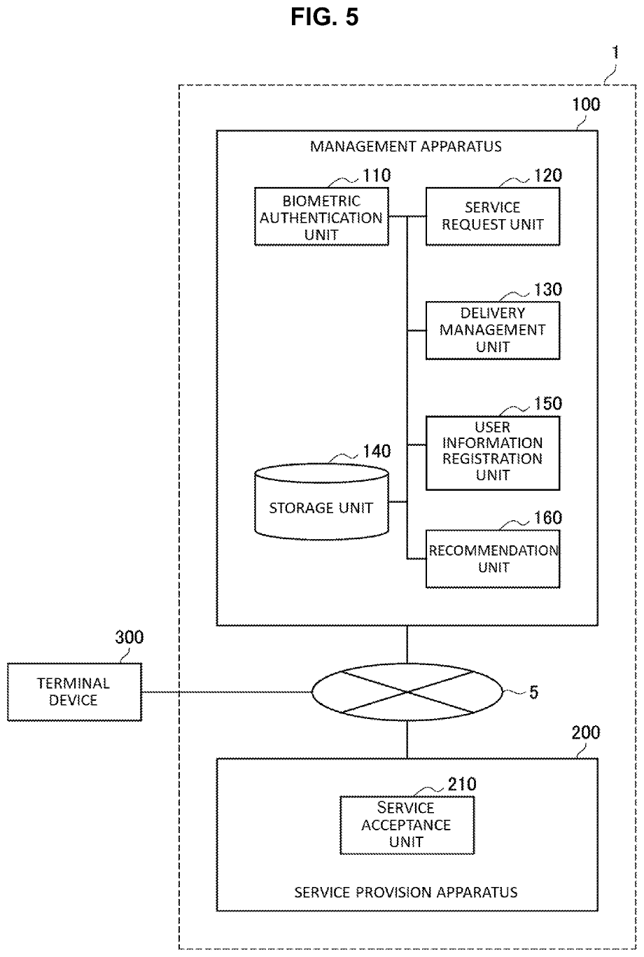

Next, a schematic configuration of a service provision system 1 according to a second example embodiment of the invention will be described based on FIG. 5. FIG. 5 is a block diagram showing an example configuration of the service provision system 1 according to the second example embodiment of the invention. The service provision system 1 according to the present example embodiment differs in having a user information registration unit 150 and a recommendation unit 160, in comparison to the service provision system 1 according to the first example embodiment shown in FIG. 3. Hereinafter, the service provision system 1 according to the present example embodiment will be described focusing on the differences from the first example embodiment, and detailed description of constituent elements similar to the first example embodiment and functions thereof will be omitted.

As shown in FIG. 5, the service provision system 1 has a management apparatus 100 and a service provision apparatus 200, similarly to the first example embodiment. The management apparatus 100 and the service provision apparatus 200 are connected to a terminal device 300 via a network 5.

The management apparatus 100 has a biometric authentication unit 110, a service request unit 120, a delivery management unit 130, a storage unit 140, a user information registration unit 150, and a recommendation unit 160. Since the biometric authentication unit 110, the service request unit 120, the delivery management unit 130 and the storage unit 140 function similarly to the first example embodiment, description thereof will be omitted here.

The user information registration unit 150 receives user information relating to a user and records the user information in association with registered biometric information of the user that is recorded in the storage unit 140. As described above, the user information includes information such as the user's interests, preferences and physique, for example, in addition to user attributes such as the user's name, address or place of stay and e-mail address. The user is able to input user information at any time using the terminal device 300, for example. The user information input by the user from the terminal device 300 is transmitted to the management apparatus 100. The user information registration unit 150 records the received user information in the storage unit 140 in association with the registered biometric information of the user.

The recommendation unit 160 notifies items available for use by the user to the terminal device 300, based on the user information recorded in the storage unit 140. The recommendation unit 160 infers items that the user will use at his or her travel destination based on the user information, from among the items available for provision by the subscription service that is used by the user, for example. The recommendation unit 160 then sends information relating to the inferred items (hereinafter also referred to as “recommendation information”) to the user via the terminal device 300. The user is able to request provision of items, with reference to the recommendation information sent to the terminal device 300.

In this way, the service provision system 1 according to the present example embodiment provides users with information relating to items that depend on the user. Users can thereby be encouraged to make full use of the subscription service within the available range of the service, and the level of satisfaction that users have with the service can be increased. Processing by the recommendation unit 160 will be described in detail later.

The service provision apparatus 200 has a service acceptance unit 210 that accepts requests from the management apparatus 100 for provision of items to biometrically authenticated users, similarly to the first example embodiment. Upon accepting a request for provision of an item, the service acceptance unit 210 requests the item provision operator to secure the item and requests the logistics operator to deliver the item, for example.

[2-2. Service Provision Processing (Recommendation Information Distribution)]

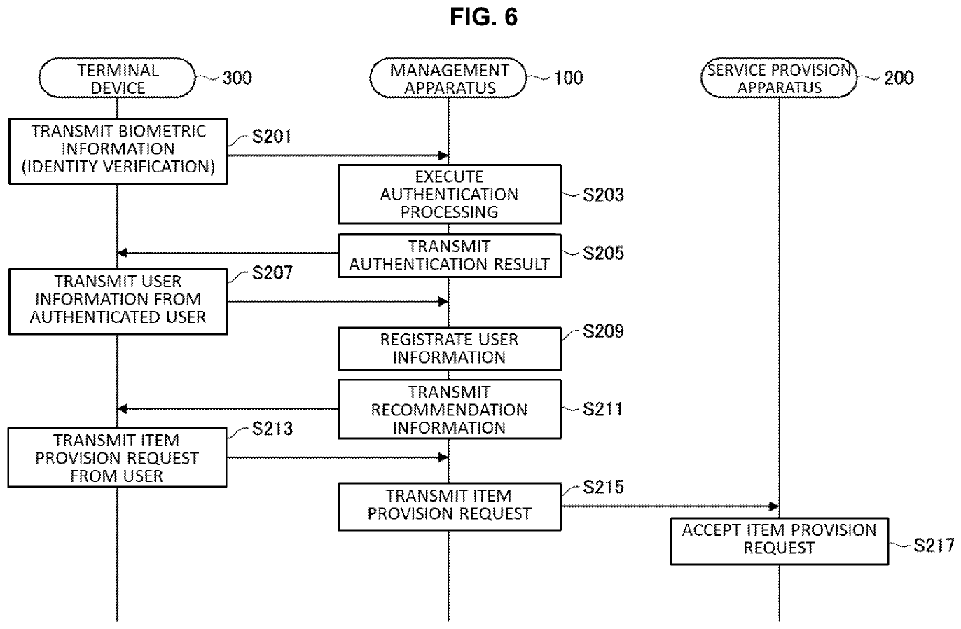

Hereinafter, processing from when a user who uses the subscription service shown in FIG. 2 receives recommendation information sent from the service provision system 1 until when the user requests an item will be described based on FIG. 6. FIG. 6 is a sequence diagram showing processing for sending recommendation information by the service provision system 1 according to the present example embodiment.

First, in order to use the service, the user acquires biometric information using the terminal device 300, and transmits the acquired biometric information to the management apparatus 100 (S201). In the case where identity verification is performed by facial recognition, for example, the terminal device 300 acquires a facial image using the image capturing apparatus 305 and transmits the captured facial image to the management apparatus 100. The image capturing apparatus 305 may be a camera provided in the terminal device 300. Alternatively, the image capturing apparatus 305 may be a separate device from the terminal device 300 and may be capable of transmitting the acquired image to the terminal device 300.

The management apparatus 100, having received the biometric information from the terminal device 300, uses the biometric authentication unit 110 to perform identity verification through comparison with the biometric information recorded in advance in the storage unit 140 (S203). The biometric authentication unit 110 transmits the authentication result to the terminal device 300 (S205).

The terminal device 300 notifies the authentication result received in step S205 to the user. If the user was not authenticated, the terminal device 300 acquires biometric information of the user again and executes processing from step S201. On the other hand, if the user was authenticated, it becomes possible for the user to use the service. In this way, the processing of steps S201 to 5205 may be performed similarly to the processing of steps S101 to 5105 shown in FIG. 4.

The user, having become able to use the service, inputs user information using the terminal device 300. The terminal device 300 transmits the input user information to the management apparatus 100 (S207). Upon receiving the user information, the management apparatus 100 uses the user information registration unit 150 to record the received user information in the storage unit 140 in association with the registered biometric information of the user (S209). The user is able to input and update user information at any time.

Next, the recommendation unit 160 of the management apparatus 100 sends recommendation information to the terminal device 300 of the user, based on the user information that is recorded in the storage unit 140 (S211). The recommendation unit 160 may send the recommendation information to the terminal device 300 of the user at a predetermined timing. For example, in the case where a user uses the service for receiving provision of items at his or her travel destination as shown in FIG. 2, the recommendation unit 160 may be configured to send the recommendation information to the terminal device 300 of the user, before the user departs to his or her destination or while the user is at the destination.

If there is an item that the user wants to use upon viewing the recommendation information, the user selects the item using the terminal device 300, and transmits a request for provision of the selected item to the management apparatus 100 (S213). The management apparatus 100, having received the item provision request, transmits the item provision request to the service provision apparatus 200 (S215). The service provision apparatus 200 accepts the item provision request (S217). The service provision apparatus 200 then requests the item provision server 400 to secure the item and requests the distribution server 500 to deliver the item, via the network 5, such that the item is delivered to the delivery place.

The item requested by the user is thus procured and delivered to the delivery place by a designated date-time. The processing of steps S213 to S217 may be performed similarly to the processing of steps S107 to S111 shown in FIG. 4. At the time that the user receives the items, the processing of steps S115 to S125 shown in FIG. 4 may be performed, as described in the first example embodiment.

[2-3. Specific Examples]

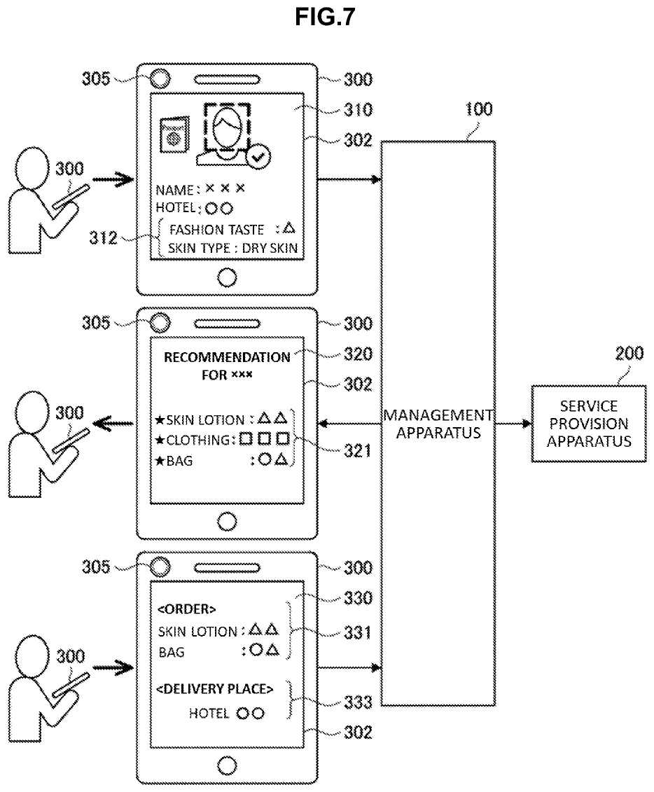

An example of recommendation information distribution processing by the service provision system 1 according to the present example embodiment will be described based on FIG. 7. FIG. 7 is an illustrative diagram showing an example of when the recommendation information distribution processing by the service provision system 1 according to the present example embodiment is implemented in the subscription service for providing items shown in FIG. 2.

When receiving provision of items by the subscription service, the user inputs user information using the terminal device 300. The upper part of FIG. 7 shows an example of a user information registration screen 310 that is displayed on a display unit 302 of the terminal device 300. User attributes such as the user's facial image and name, out of the user information registered in advance in the storage unit 140, may be displayed on the user information registration screen 310. Furthermore, in the case where the name of the hotel serving as the place of stay is registered as user information, the place of stay may also be displayed on the user information registration screen 310.

The user is able to register user information that has not yet been registered through the user information registration screen 310 at a convenient time for the user before or during his or her trip. For example, the user may input personal data such as his or her interests, preferences and physique as user information. On the user information registration screen 310 shown in the upper part of FIG. 7, the user's fashion taste indicating his or her taste in clothing, the user's skin type and the like are registered as personal data 312. The personal data 312 may be information entered by the user using the terminal device 300, or may be information selected from a pulldown menu presented on the user information registration screen 310.

The information input to the user information registration screen 310 is transmitted to the management apparatus 100, due to registration processing being performed by the user pressing a button on the terminal device 300, for example. The management apparatus 100 records the input user information in the storage unit 140 in association with the registered biometric information of the user.

Next, the recommendation unit 160 of the management apparatus 100 sends information indicating items available for use by the user through the subscription service to the terminal device 300 as recommendation information, based on the user information registered in advance. The middle part of FIG. 7 shows an example of a recommendation information display screen 320 for displaying recommendation information 321. On the recommendation information display screen 320, cosmetics, clothing and a bag are displayed as items recommended to the user. The recommendation unit 160 is able to determine the clothing and bag to recommend based on the fashion taste in the personal data 312 and determine the cosmetics to recommend based on the skin type in the personal data 312. Note that the items to recommend may be determined using a model representing the relationship between the personal data of the item user or item purchaser and items generated by machine learning, for example.

The user is able to request provision of items, with reference to the recommendation information sent to the terminal device 300. The lower part of FIG. 7 shows an example of an item provision request screen 330. Order information 331 on the item provision request screen 330 shown in the lower part of FIG. 7 includes the cosmetics and bag recommended by the recommendation information 321. The items that are included in the recommendation information 321 may be selectable on the recommendation information display screen 320 as items whose provision is requested by the user. Also, a configuration may be adopted in which the user is able to designate a delivery place 333 of the items on the item provision request screen 330.

Furthermore, a configuration may be adopted in which the user is able to designate the date-time of receipt of the items on the item provision request screen 330.

Upon inputting information required for the item provision request, such as the order information 331 and the delivery place 333, using the terminal device 300, the user transmits the item provision request to the management apparatus 100. The management apparatus 100, having received the item provision request, transmits the item provision request to the service provision apparatus 200. Upon receiving the item provision request, the service provision apparatus 200 requests the item provision server 400 to secure the items and requests the distribution server 500 to deliver the items, via the network 5, such that the items are delivered to the delivery place. The items requested by the user are thus procured and delivered to the delivery place by the designated date-time.

In this way, the service provision system 1 according to the present example embodiment provides users with information relating to items that depend on the user. Users can thereby be encouraged to make full use of the subscription service within the available range of the service, and the level of satisfaction that users have with the service can be increased.

Also, as another specific example, the recommendation unit 160, in the case where a schedule at the travel destination is registered as user information, may send the recommendation information according to the schedule. In the case where tour reservation information is registered as user information, the recommendation unit 160 may infer the user's schedule at the travel destination from the tour reservation information and send recommendation information according to the inferred schedule.

For example, assume that climbing in the mountains at the travel destination is registered as user information. Or that it is inferred that the user will go climbing in the mountains at the travel destination from tour reservation information registered as user information. In this case, the recommendation unit 160 may send information, to the terminal device 300, relating to items that will be needed for climbing in the mountains including outdoor gear such as shoes and clothing and consumables such as food and drink that that can be provided, before the user goes climbing (e.g., before departing for the travel destination or before departing to climb in the mountains).

In this way, by sending recommendation information that depends on the user's schedule, users are able to know that items that will be needed at their travel destination are available from the subscription service. Then, by receiving provision of items, users are able to travel lightly and relax at their destination, without having to get items that they will need at their destination ready beforehand or carry large pieces of luggage at their destination.

Hereinabove, the configuration of the service provision system 1 according to the second example embodiment and the service provision processing that is implemented by the service provision system 1 are described. According to the present example embodiment, information relating items that depend on the user is provided to users by the recommendation unit 160. Users can thereby be encouraged to make full use of the subscription service within the available range of the service, and the level of satisfaction that users have with the service can be increased.

Also, given that the service provision system 1 according to the present example embodiment has functional units that are provided in the first example embodiment, biometric authentication is implemented for identity verification purposes, at the time that a user receives provision of items from a business operator, similarly to the first example embodiment. If the user is authenticated by the biometric authentication unit 110, it becomes possible for the user to use the items. Also, by implementing biometric authentication on the user at the time that he or she receives provision of the items, the user who is using the service can be specified. As a result, it is possible to prevent problems such as rental items being returned in a damaged state and items being used by another person impersonating the user. In this way, the service provision system 1 makes it possible for service providers and users to transact reliably.

Note that a program for executing the service provision processing in the service provision system 1 according to the present example embodiment need only be a program that causes a computer to execute processing as the functional units shown in FIG. 5. By installing and executing this program on a computer, the management apparatus 100 and the service provision apparatus 200 of the service provision system 1 and the service provision method according to the present example embodiment can be realized. In this case, the processor of the computer functions and performs processing as the biometric authentication unit 110, the service request unit 120, the delivery management unit 130, the user information registration unit 150 and the recommendation unit 160 of the management apparatus 100. Alternatively, the processor of the computer functions and performs processing as the service acceptance unit 210 of the service provision apparatus 200.

Also, in the present example embodiment, the storage unit 140 may be realized by storing data files constituting the same in a storage device such as a hard disk provided in the computer, or may be realized by a storage device of another computer. Examples of the computer include a smartphone and a tablet terminal device, in addition to a general-purpose PC.

Furthermore, the program according to the present example embodiment may be executed by a computer system constructed from a plurality of computers. In this case the computers may, for example, respectively function as one of the biometric authentication unit 110, the service request unit 120, the delivery management unit 130, the user information registration unit 150 and the recommendation unit 160 of the management apparatus 100 and the service acceptance unit 210 of the service provision apparatus 200.

### 3. Third Example Embodiment

[3-1. System Configuration]

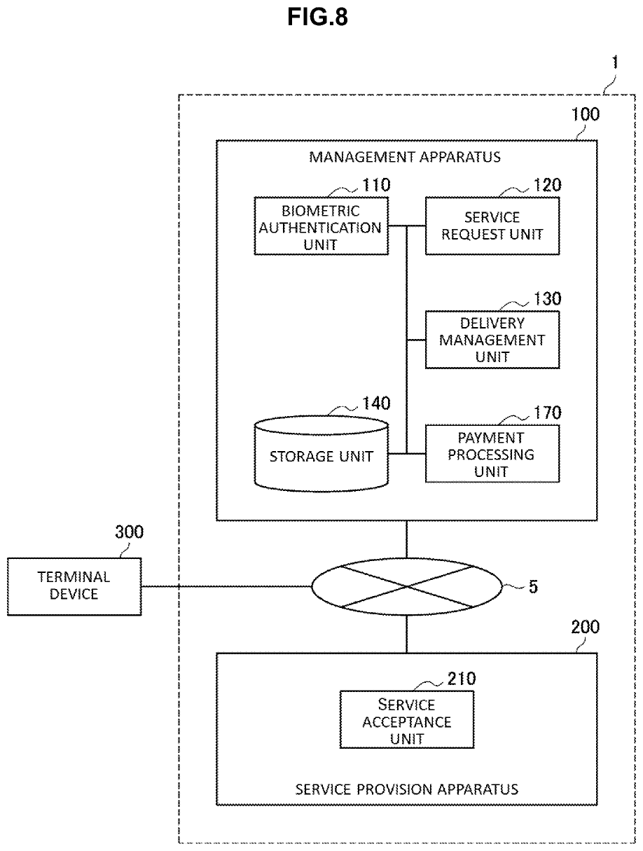

Next, a schematic configuration of a service provision system 1 according to a third example embodiment of the invention will be described based on FIG. 8. FIG. 8 is a block diagram illustrating an example configuration of the service provision system 1 according to the third example embodiment of the invention. The service provision system 1 according to the present example embodiment differs in having a payment processing unit 170, in comparison to the service provision system 1 according to the first example embodiment shown in FIG. 3. Hereinafter, the service provision system 1 according to the present example embodiment will be described focusing on the differences from the first example embodiment, and a detailed description of constituent elements similar to the first example embodiment and functions thereof will be omitted.

As shown in FIG. 8, the service provision system 1 according to the present example embodiment has a management apparatus 100 and a service provision apparatus 200, similarly to the first example embodiment. The management apparatus 100 and the service provision apparatus 200 are connected to a terminal device 300 via a network 5.

The management apparatus 100 has a biometric authentication unit 110, a service request unit 120, a delivery management unit 130, a storage unit 140 and a payment processing unit 170. Since the biometric authentication unit 110, the service request unit 120, the delivery management unit 130 and the storage unit 140 function similarly to the first example embodiment, description thereof will be omitted here.

The payment processing unit 170 performs payment processing. In the service provision system 1 according to the present example embodiment, payment based on biometric information is possible, such that the user is able to purchase items efficiently. In order to make a payment based on biometric information, the user registers payment method information as user information. The payment method information is information for performing cashless payment, such as credit card information and electronic payment service information, for example. By associating the payment method information with the registered biometric information, payment by biometric authentication becomes possible.

When a user transmits biometric information to the management apparatus 100 at the time of purchasing an item, the management apparatus 100 uses the biometric authentication unit 110 to perform biometric authentication of the user. If the user is authenticated, the payment processing unit 170 then executes payment processing based on the registered payment method information. Once payment is completed, the service request unit 120 transmits payment completion information to the service provision apparatus 200.

The service provision apparatus 200 has a service acceptance unit 210 that accepts requests for provision of items to biometrically authenticated users from the management apparatus 100, similarly to the first example embodiment. In the present example embodiment, the service acceptance unit 210 arranges delivery of purchased items. When there is a purchase request for an item, the service acceptance unit 210 confirms with the item provision server 400 whether the item can be secured, and transmits the confirmation result to the management apparatus 100. Also, upon receiving payment completion information, the service acceptance unit 210 notifies the item provision server 400 that purchase of the item is completed, and requests the distribution server 500 to deliver the item.

[3-2. Service Provision Processing (Purchase of Items)]

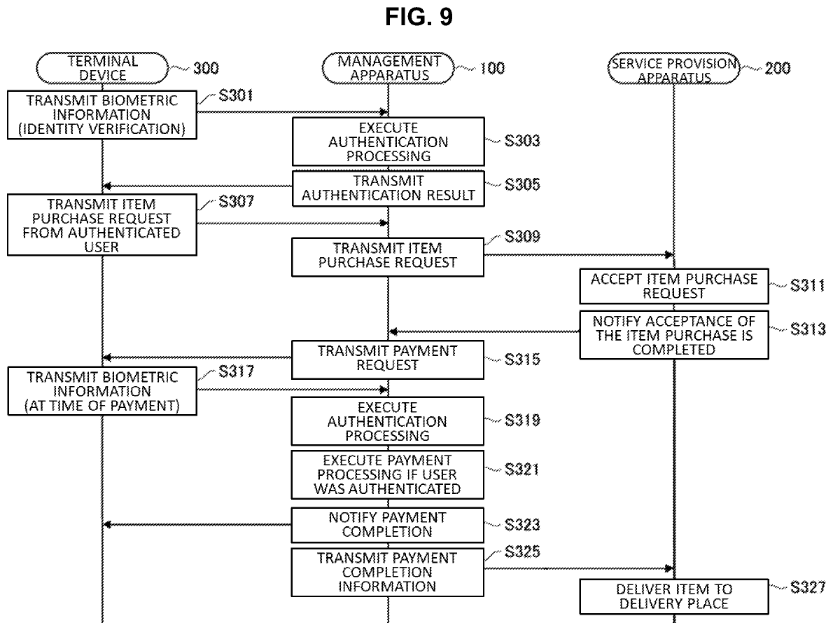

Hereinafter, processing for a user who uses the subscription service shown in FIG. 2 to purchase an item using the service provision system 1 will be described based on FIG. 9. FIG. 9 is a sequence diagram showing processing for purchasing an item by the service provision system 1 according to the present example embodiment. The subscription service shown in FIG. 2 is a service for fixed period rental of items, but it is also conceivable for users to want to purchase rental items that they like. In view of this, the convenience of the service is enhanced by making it possible to also purchase items in the service provision system 1.

First, in order to use the service, the user acquires biometric information using the terminal device 300, and transmits the acquired biometric information to the management apparatus 100 (S301). In the case where identity verification is performed by facial recognition, for example, the terminal device 300 acquires a facial image using an image capturing apparatus 305 and transmits the captured facial image to the management apparatus 100. The image capturing apparatus 305 may be a camera provided in the terminal device 300. Alternatively, the image capturing apparatus 305 may be a separate device from the terminal device 300 and may be capable of transmitting the acquired image to the terminal device 300.

The management apparatus 100, having received the biometric information from the terminal device 300, uses the biometric authentication unit 110 to perform identity verification through comparison with the biometric information recorded in advance in the storage unit 140 (S303). The biometric authentication unit 110 transmits the authentication result to the terminal device 300 (S305).

The terminal device 300 notifies the authentication result received in step S305 to the user. If the user was not authenticated, the terminal device 300 acquires biometric information of the user again and executes processing from step S301. On the other hand, if the user was authenticated, it becomes possible for the user to use the service. In this way, the processing of steps S301 to S305 may be performed similarly to the processing of steps S101 to S105 shown in FIG. 4.

The user, having become able to use the service, selects an item to be purchased using the terminal device 300, and transmits a purchase request for the selected item to the management apparatus 100 (S307). The item purchase request includes information such as the item to be purchased and the delivery place of the item to be purchased. The service request unit 120 of the management apparatus 100, having received the item purchase request, transmits the item purchase request to the service provision apparatus 200 (S309). The service provision apparatus 200 accepts the item purchase request (S311).

The service provision apparatus 200 confirms with the item providing server 400 whether the item can be secured. If the item can be secured, the service provision apparatus 200 notifies the management apparatus 100 that acceptance of the item purchase is completed (S313). Note that, if the item cannot be secured, the service provision apparatus 200 notifies the management apparatus 100 that the item cannot be purchased. The management apparatus 100 then notifies the terminal device 300 of the user that the item cannot be purchased by the user. At this time, the management apparatus 100 may also transmit information, to the terminal device 300, relating to alternative items that can be purchased by the user.

The management apparatus 100, having received notification that acceptance of the item purchase is completed from the service provision apparatus 200, transmits a payment request to the terminal device 300 of the user from the payment processing unit 170 (S315). When a payment request is received, the user acquires biometric information using the terminal device 300, and transmits the acquired biometric information to the management apparatus 100 (S317). Upon receiving the biometric information from the terminal device 300, the payment processing unit 170 of the management apparatus 100 instructs the biometric authentication unit 110 to perform comparison with the registered biometric information that is recorded in advance in the storage unit 140. The biometric authentication unit 110 compares the biometric information (S319), and outputs an authentication result to the payment processing unit 170.

The payment processing unit 170 determines whether payment for the item can be made, based on the authentication result of the biometric authentication unit 110. If the user was not authenticated, the payment processing unit 170 transmits notification that the user was not authenticated and a resend request for biometric information to the terminal device 300. In this case, the user acquires biometric information of the user again using the terminal device 300 and executes processing from step S317.

On the other hand, if the user was authenticated, the payment processing unit 170 executes payment processing based on the payment method information that is recorded in the storage unit 140 (S321). Once payment is completed, the payment processing unit 170 then notifies the terminal device 300 that payment is completed (S323). Also, the service request unit 120 transmits payment completion information to the service provision apparatus 200 via the network 5 (S325). On receiving the payment completion information, the service provision apparatus 200 notifies the item provision server 400 that purchase of the item is completed, and requests the logistics server 500 to deliver the item. The item purchased by the user is thus delivered to the delivery place by the designated date-time (S327).

Note that, at the time that the user receives the item, the processing of steps S115 to 5125 shown in FIG. 4 may be performed for identity verification purposes, as described in the first example embodiment.

[3-3. Specific Example]

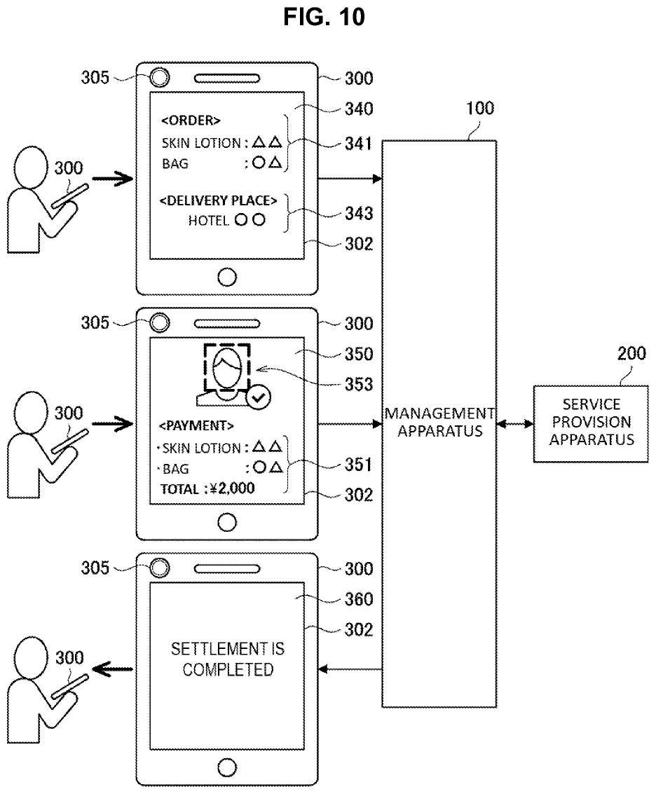

An example of payment processing by the service provision system 1 according to the present example embodiment will be described based on FIG. 10. FIG. 10 is an illustrative diagram showing an example of when payment processing by the service provision system 1 according to the present example embodiment is implemented in the subscription service for providing items shown in FIG. 2. Note that, in the following, it is assumed that the payment method information of the user has already been registered.

In the case of purchasing an item, the user inputs the item to be purchased using the terminal device 300, and transmits a purchase request for the input item to the management apparatus 100. The upper part of FIG. 10 shows an example of an item purchase request screen 340. In order information 341 on the item purchase request screen 340 shown in the upper part of FIG. 10, cosmetics and bag are displayed as the names of items to be purchased. The number, unit price and the like of the items to be purchased may be displayed in the order information 341. Also, a configuration may be adopted in which the user is able to designate a delivery place 343 of the items on the item purchase request screen 340.

Upon inputting information required for the item purchase request, such as the order information 341 and the delivery place 343, using the terminal device 300, the user transmits the item purchase request to the management apparatus 100. The service request unit 120 of the management apparatus 100, having received the item purchase request, transmits the item purchase request to the service provision apparatus 200. The service provision apparatus 200 accepts the item purchase request and confirms with the item provision server 400 whether the items can be secured. If the items can be secured, the service provision apparatus 200 notifies the management apparatus 100 that acceptance of the item purchase is completed.

The management apparatus 100, having received notification from the service provision apparatus 200 that acceptance of the item purchase is completed, transmits a payment request to the terminal device 300 of the user from the payment processing unit 170. The middle part of FIG. 10 shows an example of a payment screen 350. On the payment screen 350, the items to be purchased and the payment amount are displayed as payment information 351. Also, instruction information 353 instructing the user to transmit biometric information for payment processing purposes may be displayed on the payment screen 350.

The user checks the payment information 351 on the payment screen 350, and, if there are no errors in the payment information 351, acquires biometric information using the terminal device 300, and transmits the acquired biometric information to the management apparatus 100. Upon receiving the biometric information from the terminal device 300, the management apparatus 100 performs comparison with the registered biometric information that is recorded in advance in the storage unit 140. If the user is authenticated, the management apparatus 100 then uses the payment processing unit 170 to execute payment processing based on the payment method information that is recorded in the storage unit 140. Once payment is completed, the management apparatus 100 notifies the terminal device 300 that payment is completed. The lower part of FIG. 10 shows an example of a payment completion notification screen 360. Due to the payment completion notification screen 360 being displayed on the display unit 302 of the terminal device 300, the user is able to comprehend that payment is completed.

Also, once payment is completed, the management apparatus 100 transmits payment completion information to the service provision apparatus 200 via the network 5. On receiving the payment completion information, the service provision apparatus 200 notifies the item provision server 400 that purchase of the items is completed, and requests the logistics server 500 to deliver the items. The items purchased by the user are thus delivered to the delivery place by the designated date-time.

In this way, the service provision system 1 according to the present example embodiment enables users to purchase desired items efficiently and is able to provide a highly convenient service.

Hereinabove, the configuration of the service provision system 1 according to the third example embodiment and the service provision processing that is implemented by the service provision system 1 are described. According to the present example embodiment, the payment processing unit 170, by performing payment processing using biometric authentication, enables users to purchase desired items.

Also, given that the service provision system 1 according to the present example embodiment has functional units that are provided in the first example embodiment, biometric authentication is implemented for identity verification purposes, at the time that a user receives provision of an item from a business operator, similarly to the first example embodiment. If the user is authenticated by the biometric authentication unit 110, it becomes possible for the user to use the item. Also, by implementing biometric authentication on the user at the time that he or she receives provision of an item, the user who is using the service can be specified. As a result, it is possible to prevent problems such as rental items being returned in a damaged state and items being used by another person impersonating the user. In this way, the service provision system 1 makes it possible for service providers and users to transact reliably.

Furthermore, functions relating to the payment processing by the service provision system 1 according to the third example embodiment can also be incorporated into the service provision system 1 according to the second example embodiment.

Note that a program for executing the service provision processing in the service provision system 1 according to the present example embodiment need only be a program that causes a computer to execute processing as the functional units shown in FIG. 8. By installing and executing this program on a computer, the management apparatus 100 and the service provision apparatus 200 of the service provision system 1 and the service provision method according to the present example embodiment can be realized. In this case, the processor of the computer functions and performs processing as the biometric authentication unit 110, the service request unit 120, the delivery management unit 130 and the payment processing unit 170 of the management apparatus 100. Alternatively, the processor of the computer functions and performs processing as the service acceptance unit 210 of the service provision apparatus 200.

Also, in the present example embodiment, the storage unit 140 may be realized by storing data files constituting the same in a storage device such as a hard disk provided in the computer, or may be realized by a storage device of another computer. Examples of the computer include a smartphone and a tablet terminal device, in addition to a general-purpose PC.

Furthermore, the program according to the present example embodiment may be executed by a computer system constructed from a plurality of computers. In this case the computers may, for example, respectively function as one of the biometric authentication unit 110, the service request unit 120, the delivery management unit 130 and the payment processing unit 170 of the management apparatus 100 and the service acceptance unit 210 of the service provision apparatus 200.

### 5. Physical Configuration

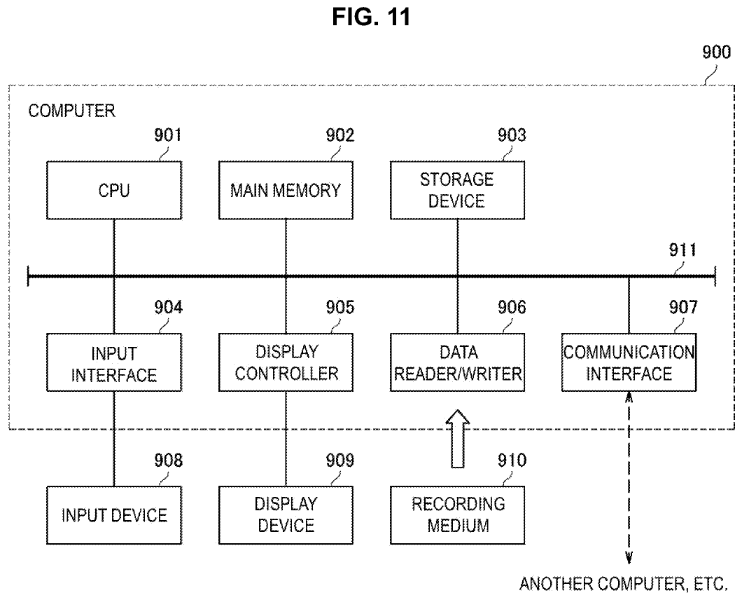

Using FIG. 11, a description is now given of a computer that realizes the management apparatus 100 by executing the program according to the present example embodiment. FIG. 11 is a block diagram illustrating one example of the computer 900 that realizes the management apparatus 100 according to a plurality of example embodiment. Note that the service provision apparatus 200 can also be realized by a computer having the physical configuration shown in FIG. 11.

As illustrated in FIG. 11, a computer 900 includes a CPU (Central Processing Unit) 901, a main memory 902, a storage device 903, an input interface 904, a display controller 905, a data reader/writer 906, and a communication interface 907. These components are connected in such a manner that they can perform data communication with one another via a bus 911.

Also, a computer 900 may include a GPU (Graphics Processing Unit) or an FPGA (Field-Programmable Gate Array) in addition to the CPU 901 or in place of the CPU 901. In this case, the GPU or the FPGA can execute the program according to the present example embodiment.

The CPU 901 carries out various types of computation by deploying the program that constituted by a group of codes according to the present example embodiment stored in the storage device 903 to the main memory 902, and executing the deployed each codes in a predetermined order. The main memory 902 is typically a volatile storage device, such as a DRAM (Dynamic Random Access Memory).

Also, the program according to the present example embodiment is provided in a state where it is stored in a computer readable recording medium 910. Note that the program according to the present example embodiment may also be distributed over the Internet connected via the communication interface 907.

Furthermore, specific examples of the storage device 903 include a hard disk drive, and also a semiconductor storage device, such as a flash memory. The input interface 904 mediates data transmission between the CPU 901 and an input device 908, such as a keyboard and a mouse. The display controller 905 is connected to a display device 909, and controls displays on the display device 909.

The data reader/writer 906 mediates data transmission between the CPU 901 and the recording medium 910, and executes readout of the program from the recording medium 910, as well as writing of the result of processing in the computer 900 to the recording medium 910. The communication interface 907 mediates data transmission between the CPU 901 and another computer.

Also, specific examples of the recording medium 910 include: a general-purpose semiconductor storage device, such as CF (Compact Flash®) and SD (Secure Digital); a magnetic recording medium, such as Flexible Disk; and an optical recording medium, such as CD-ROM (Compact Disk Read Only Memory).

Note that the management apparatus 100 according to the present example embodiment can also be realized by using items of hardware corresponding to respective components, rather than by using the computer with the program installed therein. Furthermore, a part of the management apparatus 100 may be realized by the program, and the remaining part of the management apparatus 100 may be realized by hardware.

A part or all of the aforementioned example embodiment can be described as, but is not limited to, the following (Supplementary Note 1) to (Supplementary Note 28).

(Supplementary Note 1)

A service provision system including:

a management apparatus; and

a service provision apparatus,

the management apparatus including:

a biometric authentication unit configured to perform biometric authentication of a user, based on biometric information of the user transmitted from a terminal device; and

a service request unit configured to request, if the user is authenticated, the service provision apparatus to provide an item to be used by the user, and

the service provision apparatus including:

a service acceptance unit configured to receive the request for provision of the item from the management apparatus, and accepting the request for provision of the item to the user who is biometric ally authenticated.

(Supplementary Note 2)

The service provision system according to Supplementary Note 1, in which the management apparatus includes a delivery management unit configured to manage delivery of the item to the user, and

at a time of the user receiving the item, the management apparatus uses the biometric authentication unit to perform biometric authentication of the user, based on biometric information of the user acquired at a delivery place of the item, and, if the user is authenticated, uses the delivery management unit to notify the terminal device that the item is available for pickup.

(Supplementary Note 3)

The service provision system according to Supplementary Note 2,

in which, when the user requests use of a plurality of items, the service request unit of the management apparatus notifies confirmation as to whether the plurality of items are to be received at the same time to the terminal device of the user, and, if a request for receipt of the plurality of items at the same time is received from the terminal device, notifies the request to the service provision apparatus.

(Supplementary Note 4)

The service provision system according to any one of Supplementary Note 1 to 3,

in which the management apparatus includes a user information registration unit configured to accept user information relating to the user, and

the user information registration unit associates the user information of the user transmitted from the terminal device with registered biometric information of the user registered for identity verification purposes.

(Supplementary Note 5)

The service provision system according to Supplementary Note 4,

in which the management apparatus includes a recommendation unit configured to notify an item available for use by the user to the terminal device, based on the user information.

(Supplementary Note 6) The service provision system according to Supplementary Note 4 or 5,

in which the management apparatus includes a payment processing unit configured to perform payment processing,

payment method information is associated as the user information with the registered biometric information, and

the management apparatus uses the biometric authentication unit to perform biometric authentication of the user, based on biometric information of the user transmitted from the terminal device together with a request for purchase of an item by the user, and, if the user is authenticated, uses the payment processing unit to execute the payment processing, based on the payment method information.

(Supplementary Note 7)

The service provision system according to any one of Supplementary Note 1 to 6,

in which the service provision apparatus is a device for providing a subscription service.

(Supplementary Note 8)

A service provision method including:

performing biometric authentication of a user, based on biometric information of the user transmitted from a terminal device;

requesting, if the user is authenticated, provision of an item to be used by the user; and

receiving the request for provision of the item, and accepting the request for provision of the item to the user who is biometrically authenticated.

(Supplementary Note 9)

The service provision method according to Supplementary Note 8,

in which, at a time of the user receiving the item,

performing biometric authentication of the user, based on biometric information of the user acquired at a delivery place of the item, and, if the user is authenticated, notifying the terminal device that the item is available for pickup.

(Supplementary Note 10)

The service provision method according to Supplementary Note 9,

in which, when the user requests use of a plurality of items,

notifying confirmation as to whether the plurality of items are to be received at the same time to the terminal device of the user, and, if a request for receipt of the plurality of items at the same time is received from the terminal device, performing a request for receipt of the plurality of items at the same time.

(Supplementary Note 11)

The service provision method according to any one of Supplementary Note 8 to 10,

in which associating the user information of the user transmitted from the terminal device with registered biometric information of the user registered for identity verification purposes.

(Supplementary Note 12)

The service provision method according to Supplementary Note 11,

in which notifying an item available for use by the user to the terminal device, based on the user information.

(Supplementary Note 13)

The service provision method according to Supplementary Note 11 or 12,

in which payment method information is associated as the user information with the registered biometric information,

performing biometric authentication of the user, based on biometric information of the user transmitted from the terminal device together with a request for purchase of an item by the user, and, if the user is authenticated, executing payment processing, based on the payment method information.

(Supplementary Note 14)

The service provision method according to any one of Supplementary Note 8 to 13,

in which the service provision method is a device for providing a subscription service.

(Supplementary Note 15)

A management apparatus including:

a biometric authentication unit configured to perform biometric authentication of a user, based on biometric information of the user transmitted from a terminal device; and

a service request unit configured to request, if the user is authenticated, provision of an item to be used by the user.

(Supplementary Note 16)

The management apparatus according to Supplementary Note 15,

in which the management apparatus includes a delivery management unit configured to manage delivery of the item to the user, and

at a time of the user receiving the item, the management apparatus uses the biometric authentication unit to perform biometric authentication of the user, based on biometric information of the user acquired at a delivery place of the item, and, if the user is authenticated, uses the delivery management unit to notify the terminal device that the item is available for pickup.

(Supplementary Note 17)

The management apparatus according to Supplementary Note 16,

in which, when the user requests use of a plurality of items, the service request unit notifies confirmation as to whether the plurality of items are to be received at the same time to the terminal device of the user, and, if a request for receipt of the plurality of items at the same time is received from the terminal device, performs a request for receipt of the plurality of items at the same time is received.

(Supplementary Note 18)

The management apparatus according to any one of Supplementary Note 15 to 17,

in which the management apparatus includes a user information registration unit configured to accept user information relating to the user, and

the user information registration unit associates the user information of the user transmitted from the terminal device with registered biometric information of the user registered for identity verification purposes.

(Supplementary Note 19)

The management apparatus according to Supplementary Note 18,

in which the management apparatus includes a recommendation unit configured to notify an item available for use by the user to the terminal device, based on the user information.

(Supplementary Note 20)

The management apparatus according to Supplementary Note 18 or 19,

in which the management apparatus includes a payment processing unit configured to perform payment processing,

payment method information is associated as the user information with the registered biometric information, and

the management apparatus uses the biometric authentication unit to perform biometric authentication of the user, based on biometric information of the user transmitted from the terminal device together with a request for purchase of an item by the user, and, if the user is authenticated, uses the payment processing unit to execute the payment processing, based on the payment method information.

(Supplementary Note 21)

The management apparatus according to any one of Supplementary Note 15 to 20,

in which the management apparatus is a device for providing a subscription service.

(Supplementary Note 22)

A computer-readable recording medium including a program recorded thereon, the program including instructions that cause a computer to carry out:

performing biometric authentication of a user, based on biometric information of the user transmitted from a terminal device;

requesting, if the user is authenticated, provision of an item to be used by the user; and

receiving the request for provision of the item, and accepting the request for provision of the item to the user who is biometrically authenticated.

(Supplementary Note 23)

The computer-readable recording medium according to Supplementary Note 22, that includes a program recorded thereon, the program including instructions that cause a computer to carry out:

in which, at a time of the user receiving the item,

performing biometric authentication of the user, based on biometric information of the user acquired at a delivery place of the item, and, if the user is authenticated, notifying the terminal device that the item is available for pickup.

(Supplementary Note 24)

The computer-readable recording medium according to Supplementary Note 23, that includes a program recorded thereon, the program including instructions that cause a computer to carry out:

in which, when the user requests use of a plurality of items,

notifying confirmation as to whether the plurality of items are to be received at the same time to the terminal device of the user, and, if a request for receipt of the plurality of items at the same time is received from the terminal device, performing a request for receipt of the plurality of items at the same time.

(Supplementary Note 25)

The computer-readable recording medium according to any one of Supplementary Note 22 to 24, that includes a program recorded thereon, the program including instructions that cause a computer to carry out:

in which associating the user information of the user transmitted from the terminal device with registered biometric information of the user registered for identity verification purposes.

(Supplementary Note 26)

The computer-readable recording medium according to Supplementary Note 25, that includes a program recorded thereon, the program including instructions that cause a computer to carry out:

in which notifying an item available for use by the user to the terminal device, based on the user information.

(Supplementary Note 27)

The computer-readable recording medium according to Supplementary Note 25 or 26, that includes a program recorded thereon, the program including instructions that cause a computer to carry out:

in which associating payment method information as the user information with the registered biometric information,

performing biometric authentication of the user, based on biometric information of the user transmitted from the terminal device together with a request for purchase of an item by the user, and, if the user is authenticated, executing payment processing, based on the payment method information.

(Supplementary Note 28)

The computer-readable recording medium according to any one of Supplementary Note 22 to 27, that includes a program recorded thereon, the program including instructions that cause a computer to carry out: in which performing a process for providing a subscription service.

Although the invention of the present application has been described above with reference to an example embodiment, the invention is not limited to the example embodiment described above. Various modifications apparent to those skilled in the art can be made to the configurations and details of the invention within the scope of the invention.

### INDUSTRIAL APPLICABILITY

As described above, according to the invention, it can be allow for reliable transactions between service providers and users. The invention is useful in a system that managing transactions between service providers and users.

### LIST OF REFERENCE SIGNS

1 Service provision system

5 Network

100 Management apparatus

110 Biometric authentication unit

120 Service request unit

130 Delivery management unit

140 Storage unit

150 User information registration unit

160 Recommendation unit

170 Payment processing unit

200 Service provision apparatus

210 Service acceptance unit

300 Terminal device

302 Display unit

305 Image capturing apparatus

400 Item provision server

500 Logistics server

900 Computer

901 CPU

902 Main memory

903 Storage device

904 Input interface

905 Display controller

906 Data reader/writer

907 Communication interface

908 Input device

909 Display device

910 Recording medium

911 Bus

What is claimed is:

1. A service provision system comprising:
a management apparatus; and
a service provision apparatus,
the management apparatus including:
a biometric authentication unit configured to perform biometric authentication of a user, based on biometric information of the user transmitted from a terminal device; and
a service request unit configured to request, if the user is authenticated, the service provision apparatus to provide an item to be used by the user, and
the service provision apparatus including:
a service acceptance unit configured to receive the request for provision of the item from the management apparatus, and accepting the request for provision of the item to the user who is biometrically authenticated.

2. The service provision system according to claim 1,
wherein the management apparatus includes a delivery management unit configured to manage delivery of the item to the user, and
at a time of the user receiving the item, the management apparatus uses the biometric authentication unit to perform biometric authentication of the user, based on biometric information of the user acquired at a delivery place of the item, and, if the user is authenticated, uses the delivery management unit to notify the terminal device that the item is available for pickup.

3. The service provision system according to claim 2,
wherein, when the user requests use of a plurality of items, the service request unit of the management apparatus notifies confirmation as to whether the plurality of items are to be received at the same time to the terminal device of the user, and, if a request for receipt of the plurality of items at the same time is received from the terminal device, notifies the request to the service provision apparatus.

4. The service provision system according to claim 1,
wherein the management apparatus includes a user information registration unit configured to accept user information relating to the user, and
the user information registration unit associates the user information of the user transmitted from the terminal device with registered biometric information of the user registered for identity verification purposes.

5. The service provision system according to claim 4,
wherein the management apparatus includes a recommendation unit configured to notify an item available for use by the user to the terminal device, based on the user information.

6. The service provision system according to claim 4,
wherein the management apparatus includes a payment processing unit configured to perform payment processing,
payment method information is associated as the user information with the registered biometric information, and
the management apparatus uses the biometric authentication unit to perform biometric authentication of the user, based on biometric information of the user transmitted from the terminal device together with a request for purchase of an item by the user, and, if the user is authenticated, uses the payment processing unit to execute the payment processing, based on the payment method information.

7. The service provision system according to claim 1,
wherein the service provision apparatus is a device for providing a subscription service.

8. A service provision method comprising:
performing biometric authentication of a user, based on biometric information of the user transmitted from a terminal device;
requesting, if the user is authenticated, provision of an item to be used by the user; and
receiving the request for provision of the item, and accepting the request for provision of the item to the user who is biometrically authenticated.

9. (canceled)

10. A non-transitory computer-readable recording medium including a program recorded thereon, the program including instructions that cause a computer to carry out:
performing biometric authentication of a user, based on biometric information of the user transmitted from a terminal device;
requesting, if the user is authenticated, provision of an item to be used by the user; and
receiving the request for provision of the item, and accepting the request for provision of the item to the user who is biometrically authenticated.
